(19) United States
(12) Patent Application Publication
(10) Pub. No.: US 2026/0074723 A1
(43) Pub. Date: Mar. 12, 2026

(54) METHOD AND DEVICE FOR ESTIMATING OTA OUTPUTS

(71) Applicant: Samsung Electronics Co., Ltd., Suwon-si (KR)

(72) Inventors: Heedo KANG, Suwon-si (KR); Yonghoon KIM, Suwon-si (KR); Wonki KIM, Suwon-si (KR); Yuichi AOKI, Suwon-si (KR); Sunggi YANG, Suwon-si (KR)

(21) Appl. No.: 19/389,754

(22) Filed: Nov. 14, 2025

Related U.S. Application Data
(63) Continuation of application No. PCT/KR2024/001141, filed on Jan. 24, 2024.

(30) Foreign Application Priority Data
May 16, 2023 (KR) 10-2023-0062935
Jun. 28, 2023 (KR) 10-2023-0083636

(51) Int. Cl. H04B 1/04; H04B 1/62

(52) U.S. Cl. CPC H04B 1/0475; H04B 1/62

(57) ABSTRACT

A method for estimating an over the air (OTA) output performed by a transmitting device is provided. The method includes selecting a digital pre-distortion (DPD) model to compensate for nonlinearity of the transmitting device at a rated output, obtaining characteristic information related to a relationship between a gain of the transmitting device and a nonlinearity parameter, based on the selected DPD model, and determining a gain corresponding to a minimum value of the nonlinearity parameter as a gain for the rated output, based on the characteristic information.

### CROSS-REFERENCE TO RELATED APPLICATION(S)

This application is a continuation application, claiming priority under 35 U.S.C. § 365 (c), of an International application No. PCT/KR2024/001141, filed on Jan. 24, 2024, which is based on and claims the benefit of a Korean patent application number 10-2023-0062935, filed on May 16, 2023, in the Korean Intellectual Property Office, and of a Korean patent application number 10-2023-0083636, filed on Jun. 28, 2023, in the Korean Intellectual Property Office, the disclosure of each of which is incorporated by reference herein in its entirety.

### BACKGROUND

### 1. Field

The disclosure relates to a method and an apparatus for estimating an over the air (OTA) output. More particularly, the disclosure relates to the method and the apparatus for estimating the OTA output without being affected by an external factor.

### 2. Description of Related Art

If an over the air (OTA) output of a device-under-test (DUT) is estimated, a gain and a loss occur at an OTA measurement stage (e.g., a free space, a receiving antenna, a transmission line, an instrument or other measurement stage), and accordingly it is necessary to compensate for the gain and the loss occurring at the measurement stage in a measurement value obtained through the measurement stage to acquire an accurate output value. However, since an actual degree of the gain and the loss at n the measurement stage may differ from a known notated value (e.g., process variation), a method of estimating the OTA output by compensating for the gain and the loss in the measurement value inherently provides an uncertain result.

The above information is presented as background information only to assist with an understanding of the disclosure. No determination has been made, and no assertion is made, as to whether any of the above might be applicable as prior art with regard to the disclosure.

### SUMMARY

Aspects of the disclosure are address at least the above-mentioned problems and/or disadvantages and to provide at least the advantages described below. Accordingly, an aspect of the disclosure is to provide a method and an apparatus for estimating an over the air (OTA) output.

Additional aspects will be set forth in part in the description which follows and, in part, will be apparent from the description, or may be learned by practice of the presented embodiments.

In accordance with an aspect of the disclosure, a method for estimating an over the air (OTA) output performed by a transmitting device is provided. The method includes selecting a digital pre-distortion (DPD) model to compensate for nonlinearity of the transmitting device at a rated output, obtaining characteristic information related to a relationship between a gain of the transmitting device and a nonlinearity parameter, based on the selected DPD model, and determining a gain corresponding to a minimum value of the nonlinearity parameter as a gain for the rated output, based on the characteristic information.

In accordance with another aspect of the disclosure, a transmitting device is provided. The transmitting device includes a transceiver, memory, comprising one or more storage media, storing instructions, and one or more processors communicatively coupled to the transceiver and the memory, wherein the instructions, when executed by the one or more processors individually or collectively, cause the transmitting device to select a digital pre-distortion (DPD) model to compensate for nonlinearity of the transmitting device at a rated output, obtain characteristic information related to a relationship between a gain of the transmitting device and a nonlinearity parameter, based on the selected DPD model, and determine a gain corresponding to a minimum value of the nonlinearity parameter as a gain for the rated output, based on the characteristic information.

In accordance with another aspect of the disclosure, one or more non-transitory computer-readable storage media storing one or more computer programs including computer-executable instructions that, when executed by one or more processors of a transmitting device individually or collectively, cause the transmitting device to perform operations are provided. The operations include selecting a digital pre-distortion (DPD) model to compensate for nonlinearity of the transmitting device at a rated output, obtaining characteristic information related to a relationship between a gain of the transmitting device and a nonlinearity parameter, based on the selected DPD model, and determining a gain corresponding to a minimum value of the nonlinearity parameter as a gain for the rated output, based on the characteristic information.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating an example of a method for estimating an over the air (OTA) output according to an embodiment of the disclosure;

FIG. 2 illustrates changes of an adjacent channel leakage ratio (ACLR) characteristics based on changes of effective isotropic radiated power (EIRP) of a system including a power amplifier (PA) according to an embodiment of the disclosure;

FIG. 3 illustrates changes of an ACLR value based on changes of EIRP, if digital pre-distortion (DPD) modeling is performed according to an embodiment of the disclosure;

FIG. 4 illustrates changes of an EIRP measurement value due to measurement stage loss error occurrence according to an embodiment of the disclosure;

FIG. 5 illustrates a lower side ACLR value based on a PA analog gain due to measurement stage loss error occurrence according to an embodiment of the disclosure;

FIG. 6 illustrates an upper side ACLR value based on a PA analog gain due to measurement stage loss error occurrence according to an embodiment of the disclosure;

FIG. 7 is a flowchart of a method for estimating an over the air (OTA) output according to an embodiment of the disclosure;

FIG. 8 is a flowchart of a method for estimating an OTA output performed by a transmitting device according to an embodiment of the disclosure;

FIG. 9 illustrates an example of applying a DPD model to an analog beamforming system according to an embodiment of the disclosure;

FIG. 10 illustrates an example of performing a selective action on an estimated output according to an embodiment of the disclosure;

FIG. 11 illustrates a flowchart for performing a selective action on an estimated output according to an embodiment of the disclosure;

FIG. 12 illustrates a method for estimating an OTA output using a gain index for a PA, according to an embodiment of the disclosure;

FIG. 13 is a block diagram showing an example of a configuration of a transmitting device according to an embodiment of the disclosure; and

FIG. 14 is a block diagram showing an example of a configuration of a receiving device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Also, although terms such as ‘first’ and ‘second’ may be used herein to describe various elements, these elements should not be limited by these terms. These terms are only used to distinguish one element from another.

Throughout the specification, when an element is referred to as being “connected” to another element, it may be “directly connected” to the other element or “electrically connected” to the other element with intervening elements therebetween. In addition, when a part “includes” an element, unless otherwise disclosed, the part may further include other element, not excluding the other element.

A phrase “in an embodiment” shown in various parts of the disclosure does not necessarily indicate the same embodiment.

An embodiment of the disclosure may be represented with functional block components and various processing steps. Some or all of such functional blocks may be realized by various hardware and/or software components configured to perform designated functions. For example, the functional blocks of the disclosure may be realized by one or more microprocessors, or by circuit components for a specific function. In addition, for example, the functional blocks of the disclosure may be implemented with various programming or scripting languages. The functional blocks may be implemented in algorithms executed on one or more processors. Further, the disclosure may employ conventional technologies for electronic environment setting, signal processing, and/or data processing. Terms such as “mechanism,” “element,” “indicates,” and “configuration” may be used broadly, and are not limited to mechanical or physical configurations.

In addition, connection lines or connection members between components shown in the drawings merely exemplify functional connections and/or physical or circuit connections. In an actual device, connections between components may be represented by various replaceable or additional functional connections, physical connections, or circuit connections.

The disclosure is now described in detail with reference to the attached drawings.

In the disclosure, over-the-air (OTA) output estimation indicates estimating wireless characteristics of a device-under-test (DUT). For example, an OTA output estimation method of the disclosure may estimate that a transmitting device output (e.g., effective isotropic radiated power (EIRP)) of the DUT is outputting a targeted output. Calibration in the disclosure may indicate inputting a known standard value into an instrument system. For example, calibrating the output of the DUT in the disclosure may indicate inputting into the instrument system that an output value at a null value is the targeted output. The targeted output mentioned above may indicate an output to be predicted through the OTA output estimation method, and may be expressed as a target output or a rated output.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi™) chip, a Bluetooth™ chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

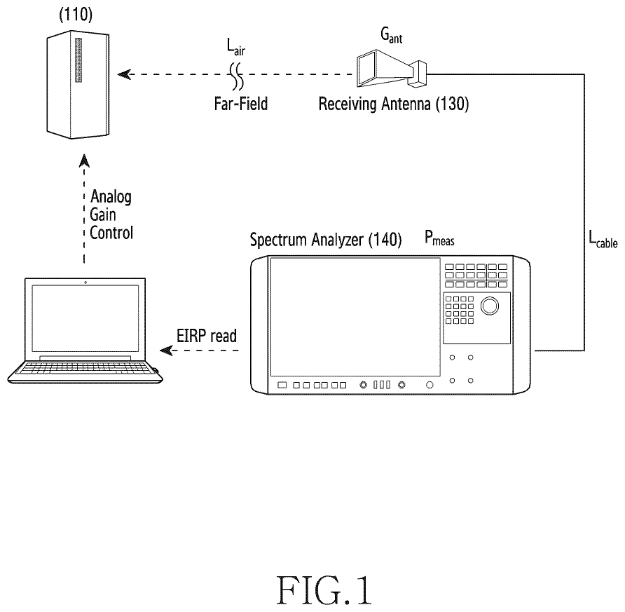

FIG. 1 is a diagram illustrating an example of a method for estimating an OTA output according to an embodiment of the disclosure.

The method for estimating the OTA output according to an embodiment of the disclosure may estimate an OTA output of the DUT without being affected by an external factor such as an external loss and a gain.

The DUT may be, for example, a base station 110. The disclosure illustrates the DUT as the base station, which is only an example, and the disclosure is not limited to the base station.

The OTA output may be, for example, effective isotropic radiated power (EIRP). In FIG. 1, a signal transmitted by the base station 110 (e.g., a signal for estimating the EIRP of the base station) may be amplified by a power amplifier (PA) and radiated through a transmitting antenna. For example, the EIRP may be an output in consideration of a gain of the transmitting antenna in the PA output.

The method for estimating the OTA output according to an embodiment of the disclosure may estimate the OTA output of the DUT based on the PA gain of the DUT. Accordingly, there is no need to compensate for errors caused by factors existing outside the DUT. More specifically, the method for estimating the OTA output according to an embodiment of the disclosure may estimate the OTA output of the DUT based on the PA gain of the DUT, by using linearity compensation characteristics of digital pre-distortion (DPD).

Further, the method for estimating the OTA output according to an embodiment of the disclosure may estimate the OTA output of the DUT by measuring adjacent channel leakage ratio (ACLR) or error vector magnitude (EVM) information based on the PA gain of the DUT by using the linearity compensation characteristics of the DPD.

A DPD model according to an embodiment may be selected to compensate for nonlinearity of the PA at the targeted output. The PA has its own nonlinearity depending on a temperature or an output (or the gain). Hence, the PA may operate most linearly at the target output, as a result of using a DPD function which is set to minimize the nonlinearity of the PA at the target output.

The method for estimating the OTA output according to an embodiment may use a parameter which quantifies the nonlinearity of the PA, to acquire a PA analog gain point at which the PA operates most linearly. The nonlinearity parameter may include, for example, one of the ACLR or the EVM.

As a result of applying the DPD model according to an embodiment, since the PA operates most linearly at the target output, the nonlinearity parameter (e.g., an ACLR value or an EVM value) may have a minimum value at the target output. At an output smaller or greater than the target output, the nonlinearity of the PA may not be compensated by the DPD model to the maximum, and accordingly the nonlinearity parameter has a value greater than the minimum value described above. Thus, as a result of applying the DPD model, if a graph of the PA output (or the gain)—nonlinearity parameter is depicted, the graph of the PA output—nonlinearity parameter may have a minimum null point at the target output. If the PA operates most linearly at a specific output (or a specific gain), or if the nonlinearity parameter has a minimum value at a specific output, the corresponding output may be inferred as a DPD model design point.

For example, a DPD model for compensating for the nonlinearity at the target output of 60 dBm may be selected. Based on the selected DPD model for 60 dBm, characteristic information relating to relationship between the output of the transmitting device including the PA and the nonlinearity parameter may be acquired. Based on the characteristic information of the relationship between the output of the transmitting device including the PA and the nonlinearity parameter, the output of the transmitting device if the nonlinearity parameter is at a minimum value may be determined as the target output. However, herein, the output of the transmitting device may be estimated from an output measured by the instrument. The output value estimated by compensating for an error due to the external factor from the instrument measurement output may not reflect the actual output. For example, even if the DPD model for compensating for the nonlinearity at the target output of 60 dBm is applied, the output if the nonlinearity parameter is the minimum value, which is the value estimated from the instrument measurement output, may not be 60 dBm.

More specifically, in a conventional method of estimating the OTA output, the base station 110 may transmit a signal for estimating the OTA output to a receiving antenna 130 through a wireless communication system. The signal received through the receiving antenna 130 may be measured through an instrument 140. The instrument 140 may obtain measurement power Pₘₛₐₛ.

Conventionally, the EIRP EIRPₑₛₜ of the DUT is estimated by compensating for a gain and a loss of external factors of the DUT (hereafter, referred to as an ‘external loss’) from the measurement output Pₘₛₐₛ obtained through the instrument 140. This may be expressed as Equation 1.

$${EIRP}_{est} = {P}_{meas} + {L}_{air} + {L}_{cable} - {G}_{ant} [ dB ] \qquad Equation 1$$

Lₐᵢᵣ may be referred to as a power loss (a loss air or a space loss) by the free space.

L_{cable} may be referred to as power lost by a transmission line.

Gₐₙₜ may be referred to as the gain of the receiving antenna.

Lₐᵢᵣ, L_{cable}, or Gₐₙₜ used in Equation 1 are the calculated values or the notated values. Hence, the method for obtaining EIRPₑₛₜ by compensating for the gain or the loss of the external factors based on Equation 1 may acquire the inaccurate EIRPₑₛₜ by a total sum of each error range, due to a possible error in the calculated value or the notated value Lₐᵢᵣ, L_{cable}, or Gₐₙₜ of the gain or the loss of the external factors. For example, if the calculated values or the notated values of Lₐᵢᵣ, L_{cable}, and Gₐₙₜ have a deviation of +/−3 dB from the actual value, EIRPₑₛₜ estimated based on Equation 1 may be subjected to the error up to 9 dB. In addition, the gain or the loss of the external factors includes a product variation which may exist in the instrument itself.

Unlike the conventional OTA output estimation method, the method for estimating the OTA output according to an embodiment does not need to compensate for the gain or the loss of the external factors, and thus may block the possibility of the error in the OTA output caused by the error of the gain or the loss of the external factors.

The OTA output estimation method according to an embodiment of the disclosure may obtain the characteristic information relating to the relationship between the gain of the PA and the nonlinearity parameter, based on the DPD model for compensating for the nonlinearity in the target output. The gain of the PA does not need to consider the error caused by the external factor, unlike the instrument measurement output to be compensated for a free space loss (a pass loss), a cable loss, a receiving antenna gain, an instrument gain/loss, and so on. Hence, the PA gain if the nonlinearity parameter is at the minimum value is reliable based on the characteristic information on the relationship between the gain of the PA and the nonlinearity parameter.

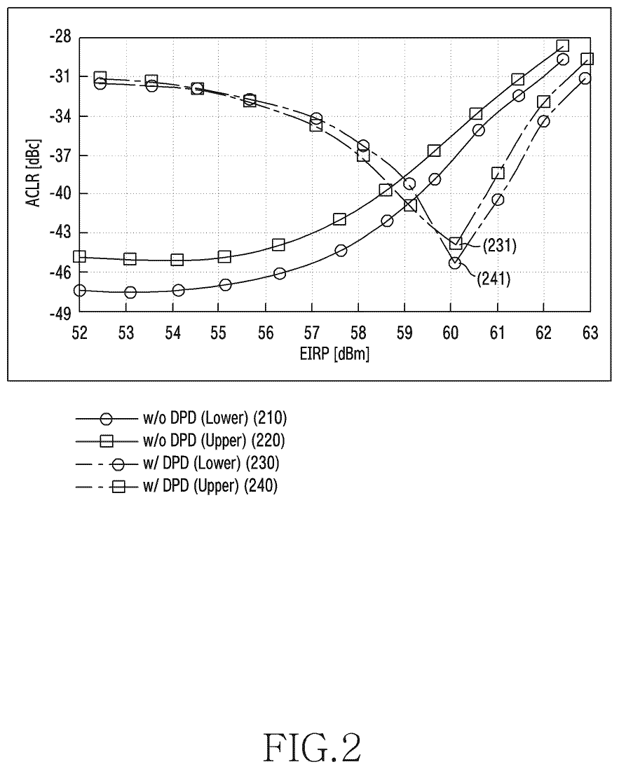

FIG. 2 illustrates changes of an ACLR based on changes of EIRP of a system including a PA according to an embodiment of the disclosure.

Specifically, FIG. 2 is a graph illustrating the ACLR change based on the EIRP change, depending on whether DPD modeling is performed according to an embodiment of the disclosure.

210 and 220 indicate the ACLR change based on the EIRP change, if the DPD modeling is not performed. The PA linearly operates with smaller outputs and nonlinearly operates with greater outputs, which may be represented as 210 and 220. The PA has (or, exhibits) inherent nonlinearity depending on the temperature and the output (or the gain).

The OTA output estimation method according to an embodiment of the disclosure may adopt the DPD model, which is a linearization technique for compensating for the nonlinearity of the PA. Since the nonlinearity of the PA is unique depending on the temperature and the output (or the gain), the DPD model is also unique depending on the temperature and the output (or the gain). For example, a DPD model designed to compensate for the nonlinearity of the PA if the output is 57 dBm and a DPD model designed to compensate for the nonlinearity of the PA if the output is 60 dBm may be different from each other. Hereafter, if the DPD model is designed to compensate for the nonlinearity of the PA at the designated output, the designated output may be understood as the target output.

If the DPD modeling according to an embodiment is performed, the PA may operate most linearly at the target output, and increase in nonlinearity at the output (or the gain) smaller or greater than the target output. Hence, if the DPD modeling is performed, the ACLR value of the PA may have a minimum value at the target output. Hereafter, the minimum value of the ACLR (or the EVM) indicating the nonlinearity degree (level) of the PA may be referred to as a null value. In addition, the EIRP (or the gain) having the smallest ACLR value may be referred to as a null point.

230 and 240 represent the ACLR change based on the EIRP change, if the DPD modeling is performed. For example, as shown in 230 and 240 of FIG. 2, if using the DPD model designed to compensate for the nonlinearity of the PA at the EIRP of 60 dBm, the PA operates most linearly at the EIRP of 60 dBm, and increase in nonlinearity at the output smaller than or equal to 60 dBm. 230 and 240 have the minimum ACLR value 231 and 241, if the EIRP is approximately 60 dBm.

The OTA output estimation method according to an embodiment may use the ACLR or the EVM, as a parameter for estimating the nonlinearity degree (hereafter, a nonlinearity parameter). For example, as shown in FIG. 2, the ACLR value may be recorded to quantify the nonlinearity degree of the PA. In various embodiments of the disclosure, the ACLR value is used to quantify the nonlinearity degree of the PA, but the ACLR value is only an example and does not limit the disclosure, and a characteristic having a unique value based on the gain of the PA may be used instead of the ACLR value.

The OTA output estimation method according to an embodiment may be used, for example, to measure EIRP transmitted from an adjacent base station. The method for estimating the EIRP has been described in various embodiments of the disclosure, which is only an example, the disclosure is not limited to the method for estimating the EIRP, and it is noted that the OTA output estimation method of the disclosure may be applied to any output which may be measured in the OTA situation.

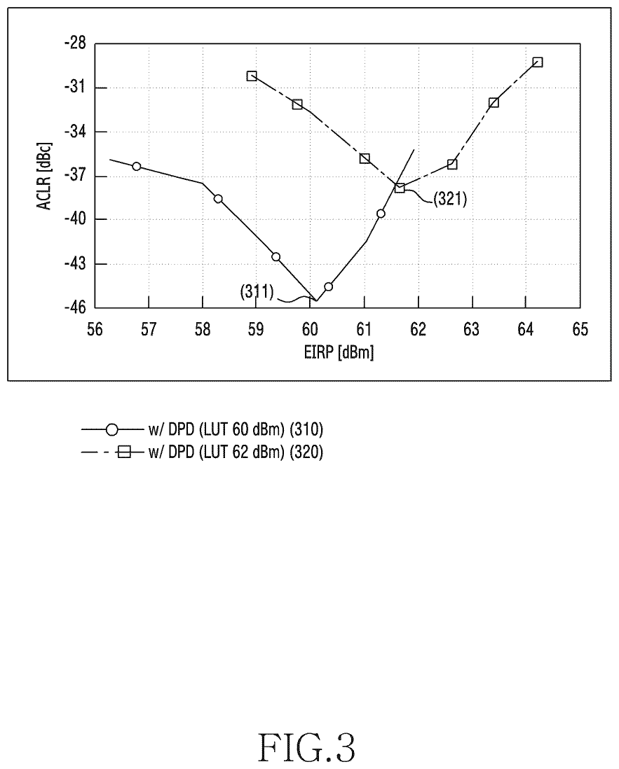

FIG. 3 illustrates ACLR value changes based on EIRP changes, if DPD modeling is performed according to an embodiment of the disclosure. Specifically, FIG. 3 represents the ACLR value for a system in which nonlinearity is compensated through the DPD modeling.

For example, 310 shows results of using the DPD model designed to compensate for the nonlinearity if the output is 60 dBm. If the DPD model designed to compensate for the nonlinearity at the EIRP of 60 dBm is used, the compensated system operates most linearly at the output of 60 dBm, and the ACLR value of the system may have a minimum value at the output of 60 dBm. Referring to FIG. 3, 310 has a minimum value 311 at about 60 dBm.

For example, 320 is results of using the DPD model designed to compensate for the nonlinearity if the output is 62 dBm. If the DPD model designed to compensate for the nonlinearity at the output of 62 dBm is used, the compensated system operates most linearly at the output of 62 dBm, and the ACLR value of the system may have a minimum value at the output is 62 dBm. Referring to FIG. 3, 320 has a minimum value 321 at about 62 dBm.

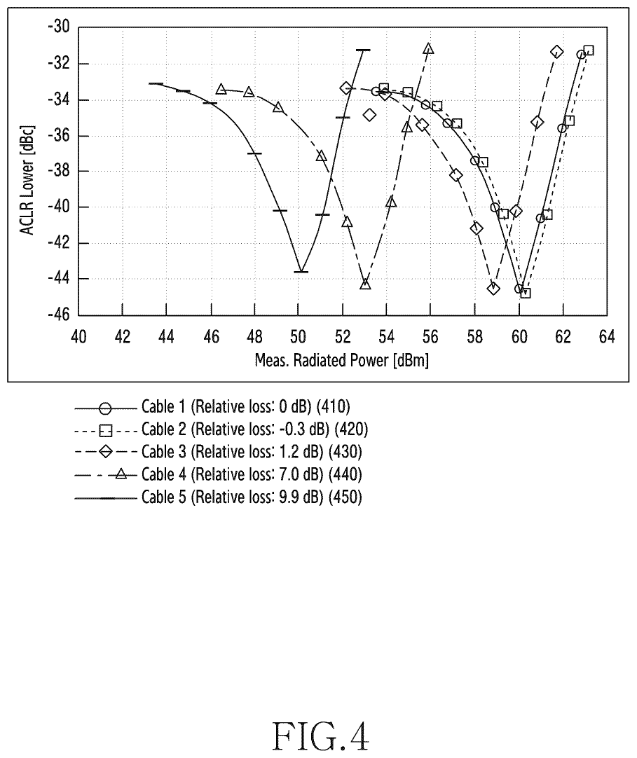

FIG. 4 illustrates changes of an EIRP measurement value EIRPₑₛₜ based on a measurement stage loss error according to an embodiment of the disclosure.

The measurement stage loss error may indicate an error caused by the gain or the loss at the OTA measurement stage, or an error caused by the external factor described above (the external loss). The EIRP measurement value may indicate an output measured or presented (or obtained) by the instrument for the EIRP prediction.

Referring to FIG. 4, an X-axis value of the graph shows the EIRP measurement value EIRPₑₛₜ, and a y-axis value shows a lower side ACLR value. Specifically, the graph of FIG. 4 represents the EIRP measurement value and the lower side ACLR value obtained under five conditions 410 through 450 in which the actual external loss is different.

For example, 410 through 450 of FIG. 4 may be understood as cases where the instrument performs measurement at a first mass production site through a fifth mass production site respectively. The first mass production site through the fifth mass production site may be understood as measurement environments in which the actual external loss is different from each other.

A relative loss of FIG. 4 may indicate a change amount of the actual external loss of each condition compared to the actual external loss of 410. For example, the relative loss of each condition may indicate the change amount that the actual external loss of each condition increases compared to the actual external loss of 410. Specifically, the actual external loss of 420 may be 0.3 dB smaller than the actual external loss of 410, and the relative loss of 420 may be expressed as −0.3 dB. Alternatively, the actual external loss of 430 may be 1.2 dB greater than the actual external loss of 410 the environment.

The EIRP measurement value EIRPₑₛₜ of FIG. 4 may be obtained by compensating for the external loss in the instrument measurement output Pₘₛₐₛ, as shown in Equation 1. The value used to compensate for the external loss in the instrument measurement output may be referred to as, for example, an instrument correction value. One instrument correction value may be used in each condition of FIG. 4. For example, the instrument correction value used in 410 may be also used in 420 through 450. According to FIG. 4, the EIRP measurement value EIRPₑₛₜ changes depending on the magnitude of the relative loss. This may indicate that the actual external loss may not be properly compensated because the same instrument correction value is used for 410 through 450 having the different actual external losses.

The horizontal axis of the graph in FIG. 4 may account for the change in the EIRP measurement value based on the relative loss, and the vertical axis may account for the change in the lower side ALCR value based on the change of the EIRP measurement value.

FIG. 4 may adopt ‘the DPD model designed to compensate for the nonlinearity if the actual output is 60 dBm’. Since the DPD model applied to the system is designed to compensate for the nonlinearity if the actual output is 60 dBm, it may operate most linearly at the actual output of 60 dBm. It is ideal to have the minimum value (or the null value) of the ACLR if the measured output is 60 dBm.

410 shows the output versus ACLR value characteristics of the system with the relative loss of 0 dB. For example, the instrument correction value used in 410 may properly compensate for the actual external loss of 410. Hence, since the EIRP measurement obtained in 410 may reflect the actual EIRP, 410 has the minimum value of the ACLR if the EIRP measurement value is exactly 60 dBm.

In 420 through 450 of FIG. 4, the EIRP measurement values having the minimum ACLR value do not match 60 dBm, unlike in 410. The reason why the EIRP measurement value having the minimum ACLR value in 420 through 450 of FIG. 4 is not 60 dBm is because the measurement output obtained through the instrument is affected by the external loss, and the used instrument correction value may not properly compensate for this external loss. The actual output is expected to be the same as 60 dBm in all of 410 through 450 at the point where the ACLR value has the null value, but the EIRP measurement value may become inaccurate as in 420 through 450 if the external loss is not accurately compensated.

420 shows the EIRP measurement value versus ACLR value characteristics of the system with the relative loss of −0.3 dB, where the same instrument correction value as in 410 is applied. Since the actual external loss of 420 is 0.3 dB smaller than the actual external loss of 410, the actual external loss may not be properly compensated even by using this instrument correction value. 420 has the minimum value of the ACLR if the EIRP measurement value is about 60.3 dBm greater than 60 dBm, as shown in FIG. 4.

430 shows the EIRP measurement value versus ACLR value characteristics of the system with the relative loss of 1.2 dB, and the same instrument correction value as in 410 is applied. Since the actual external loss of 430 is 1.2 dB greater than the actual external loss of 410, the actual external loss may not be properly compensated even by using this instrument correction value. 430 has the minimum value of the ACLR if the EIRP measurement value is about 58.8 dBm smaller than 60 dBm, as shown in FIG. 4.

440 shows the EIRP measurement value versus ACLR value characteristics of the system with the relative loss of 7.0 dB, where the same instrument correction value as in 410 is applied. 440 has the minimum value of the ACLR if the EIRP measurement is about 53.0 dBm smaller than 60 dBm, as shown in FIG. 4. 450 shows the EIRP measurement value versus ACLR value characteristics of the system with the relative loss of 9.9 dB, where the same instrument correction value as in 410 is applied. 450 has the minimum value of the ACLR if the EIRP measurement is about 50.1 dBm smaller than 60 dBm, as in FIG. 4.

In other words, if the external loss affecting the measurement output of the instrument is not fully compensated, the EIRP measurement value at the minimum value may not reflect the actual output, which may cause confusion in the OTA measurement. Take an example that the external loss increases by 9.9 dB in 450 (i.e., the relative loss is 9.9 dB), if the instrument correction value does not accurately reflect the increased external loss, even though the actual system output is maintained at 60 dBm, the output at the null point may be identified as about 50.1 dBm, resulting in mistaking that the target output is designed as about 50.1 dBm.

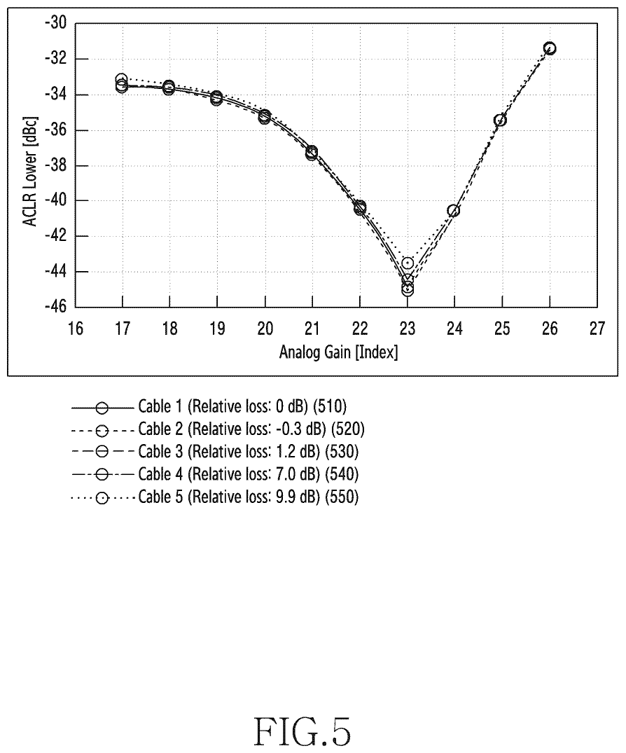

FIG. 5 illustrates a lower side ACLR value based on a PA analog gain if a measurement stage loss error occurs according to an embodiment of the disclosure.

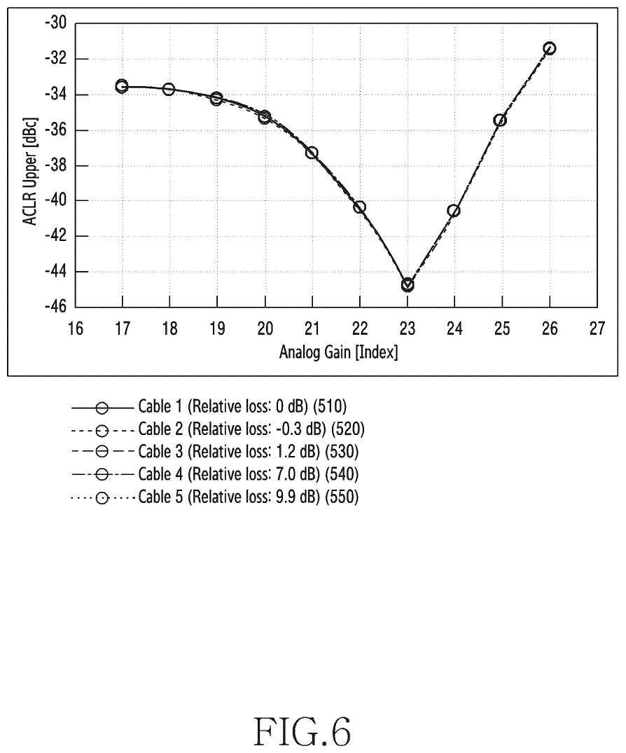

FIG. 6 illustrates an upper side ACLR value based on a PA analog gain if a measurement stage loss error occurs according to an embodiment of the disclosure.

In the disclosure, the unit of the analog gain may be expressed as an index. In the disclosure, the analog gain of the PA, which is a value identified by the DUT, may be understood as a value obtained by dividing the supply power of the transmitting antenna of the transmitting device by the supply power of the PA. For example, the EIRP may be understood as a value obtained by multiplying the analog gain of the PA by the supply power of the PA and the gain of the transmitting antenna.

The OTA output estimation method according to an embodiment may estimate that the OTA output has the target output. The OTA output estimation method may specify the analog gain of the PA for producing a designated OTA output in a reference environment (e.g., an environment includes the temperature, the external loss, etc.). The OTA output estimation method may design a DPD model for compensating for the nonlinearity of the PA at the designated analog gain of the PA (i.e., the gain for the target output). The OTA output estimation method may identify the gain for the target output from the null point of the analog gain-ACLR graph. In other words, the OTA output estimation method may identify the gain for the target output from the analog gain having the minimum value of the ACLR value. The OTA output estimation method may estimate that the OTA output is the target output from the identified gain.

For example, the OTA output estimation method according to an embodiment may estimate that the OTA output is 60 dBm, as shown in FIGS. 5 and 6. For doing so, if the EIRP measured in the reference environment is 60 dBm, the analog gain of the PA for the 60 dBm output may be specified. In FIGS. 5 and 6, the designated analog gain is 23 index.

For example, FIGS. 5 and 6 assume an embodiment which adopts a ‘DPD model designed to compensate for the nonlinearity of the PA if the analog gain is 23 index’. Since the DPD model applied to the system is designed to compensate for the nonlinearity of the PA if the analog gain is 23 index, it may operate most linearly at the analog gain of 23 index. It is ideal to have the minimum value of the ACLR if the analog gain is 23 index.

FIGS. 5 and 6 illustrate the change of the ACLR value based on the analog gain change of the PA, unlike FIG. 4. Since the analog gain of the PA is the value identified by the PA, unlike the output measured by the instrument outside the PA, it may not be affected by the external loss. Accordingly, if the DPD model designed to compensate for the nonlinearity if the analog gain is 23 index is applied, even though the output is measured by the instrument at a mass production site with a different external loss, the null point may always be formed at the 23 index.

Hence, if the DPD model designed to compensate for the nonlinearity if the analog gain is index 23 is applied, since the PA analog index corresponds to 23 at the null point, it may be estimated that the designated output is produced at the null point. The OTA output estimation method may enable a user to estimate, for example, that the rated output is produced.

FIGS. 5 and 6 show the analog gain versus ACLR value characteristics of the system in which the external loss of 510, 520, 530, 540, and 550 varies by 0 dB, −0.3 dB, 1.2 dB, 7.0 dB, and 9.9 dB, respectively, compared to the actual external loss. Referring to FIGS. 5 and 6, regardless of the change in the external loss of the system, 510, 520, 530, 540, and 550 all have the minimum value of the ACLR at the analog gain index of 23.

In the graph of the analog gain versus ACLR value characteristics, it may be inferred that the 23 index is the gain for the target output, based on the ACLR having the minimum value if the analog gain is 23 index. Further, it may be inferred that the actual output of 60 dBm is the target output.

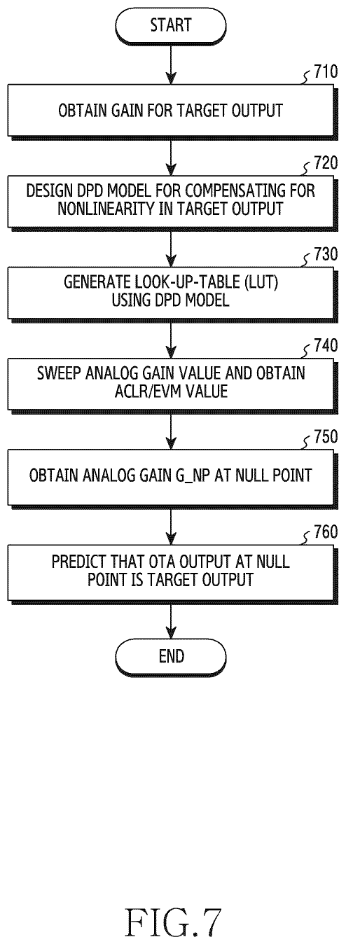

FIG. 7 is a flowchart of an OTA output estimation method according to an embodiment of the disclosure. Specifically, the OTA output estimation method may estimate that the OTA output has a targeted output value (hereafter, a designated OTA output). For example, if estimating the rated output of 60 dBm, the designated OTA output indicates 60 dBm.

The OTA output estimation method may obtain the analog gain of the PA for achieving the designated OTA output in the reference environment (e.g., the environment includes the temperature, the external loss, etc.). For example, the transmitting device may obtain the analog gain of the PA for achieving the designated OTA output. For example, in operation 710, the transmitting device may record (obtain) the analog gain value of the PA if the EIRP is 60 dBm. If recording the analog gain value of the PA at the designated OTA output, the designated OTA output may be measured in the reference environment. The analog gain of the PA for achieving the designated OTA output in the reference environment may be expressed as a PA analog gain.

The OTA output estimation method may design a DPD model to compensate for the nonlinearity of the PA in the PA analog gain. For example, the PA analog gain may be used as the gain for the target output. In operation 720, the transmitting device may dump a pattern related to the PA analog gain, and design (build) a DPD model. The DPD model may be designed to compensate for the nonlinearity of the PA in the PA analog gain.

The OTA output estimation method may compensate for the nonlinearity in the PA analog gain obtained using the DPD model. The DPD modeling technique may include a memoryless model, a memory model, or a generalized memory polynomial model. In operation 730, a look-up-table (LUT) may be generated to use the DPD model in the transmitting device.

The OTA output estimation method may operate the DUT to use a DPD mode in the generated LUT. In operation 740, the transmitting device may sweep the PA analog gain and obtain an ACLR or EVM value corresponding to the analog gain.

The OTA output estimation method may identify the gain for the target output from the null point of the PA analog gain-ACLR graph. For example, in operation 750, the PA analog gain (hereafter, G_{NP}) at the null point of the ACLR or EVM value may be identified (or obtained).

The OTA output estimation method may predict that the OTA output at the PA analog gain G_{NP} is the target output, based on the fact that the designed DPD model has the null point at the target output.

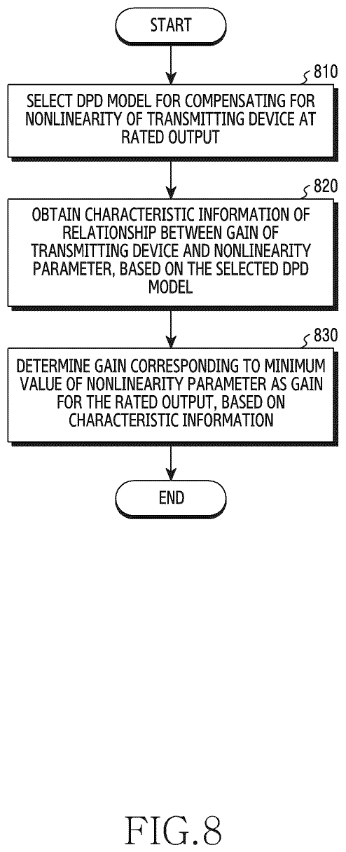

FIG. 8 is a flowchart of a method for estimating an OTA output performed by a transmitting device according to an embodiment of the disclosure.

The method for estimating the OTA output performed by the transmitting device according to an embodiment of the disclosure may estimate the OTA output of the transmitting device, without being affected by an external factor (e.g., a temperature or a gain of equipment, etc.).

In operation 810, the transmitting device may select a DPD model for compensating for the nonlinearity at the rated output. In FIG. 8, the transmitting device may be expressed as the DUT. For example, the transmitting device may be a base station or a terminal. The DPD model for compensating for the nonlinearity at the rated output may enable the PA included in the transmitting device to operate most linearly at the rated output.

In operation 820, the transmitting device may obtain characteristic information related to the relationship between the gain of the transmitting device and the nonlinearity parameter, based on the selected DPD model. The transmitting device may obtain the characteristic information related to the relationship between the PA gain and the nonlinearity parameter, to acquire the PA gain point at which the PA operates most linearly. The nonlinearity parameter may include, for example, the ACLR or the EVM.

In operation 830, the transmitting device may determine, based on the characteristic information, a gain corresponding to the minimum value of the nonlinearity parameter as the gain for the rated output. As a result of applying the DPD selected to compensate for the nonlinearity at the target output, the nonlinearity parameter may have a minimum value at the rated output. The transmitting device may determine the gain at which the nonlinear parameter has the minimum value as the gain for the rated output. The transmitting device may estimate that the actual output of the transmitting device corresponds to the rated output at the point where the nonlinear parameter has the minimum value based on the PA gain at the point where the nonlinear parameter has the minimum value.

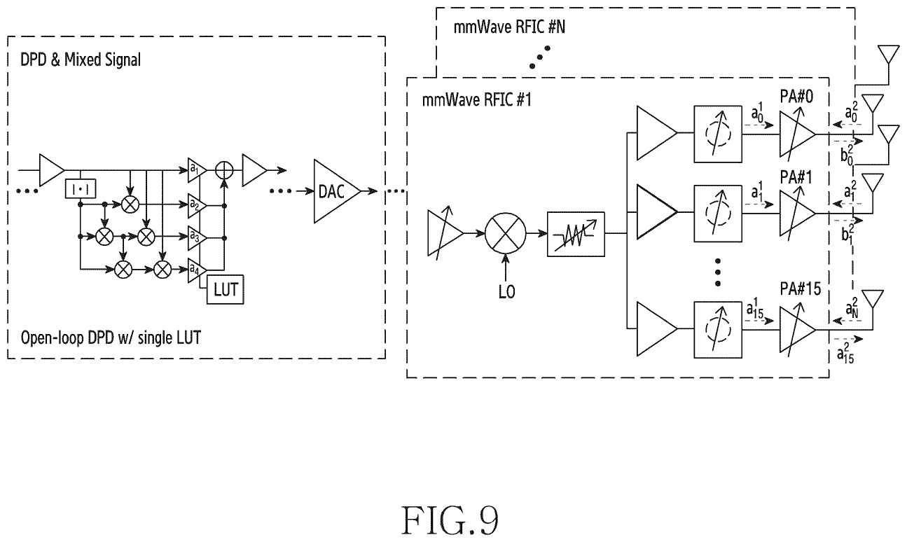

FIG. 9 illustrates an example of applying a DPD model to an analog beamforming system according to an embodiment of the disclosure.

FIG. 9 illustrates an active phased array antenna configuration including a plurality of PAs, a plurality of phase shifters and a plurality of antenna elements for beamforming. The beamforming system may form a beam for a specific location by adjusting the plurality of phase shifters, and calibrate the output at the origin of the far field for initial output calibration.

The DPD model may reduce distortion occurring if the PA operates in a nonlinear region, and improve efficiency of the PA. The OTA output estimation method according to an embodiment may use the DPD model for compensating for the nonlinearity in a designated OTA target output. By using the DPD model for compensating for the nonlinearity in the designated OTA target output, an ACLR value extracted from the PA analog gain may have a minimum value at the designated OTA target output.

For example, in operation 710 of FIG. 7, the DPD model of FIG. 9 may be designed to compensate for the specified PA analog gain value. In operation 720, the change in the ACLR value for the change in the PA analog gain value may be obtained (identified) in operation 740 by using the DPD model of FIG. 9. In operation 750, the analog gain at the minimum value of the ACLR may be obtained. In operation 760, it may be estimated that the PA analog gain at the null point (the minimum value of the ACLR) is the value for producing the OTA target output. In the disclosure, producing the target output may include enabling the OTA output to achieve the target output.

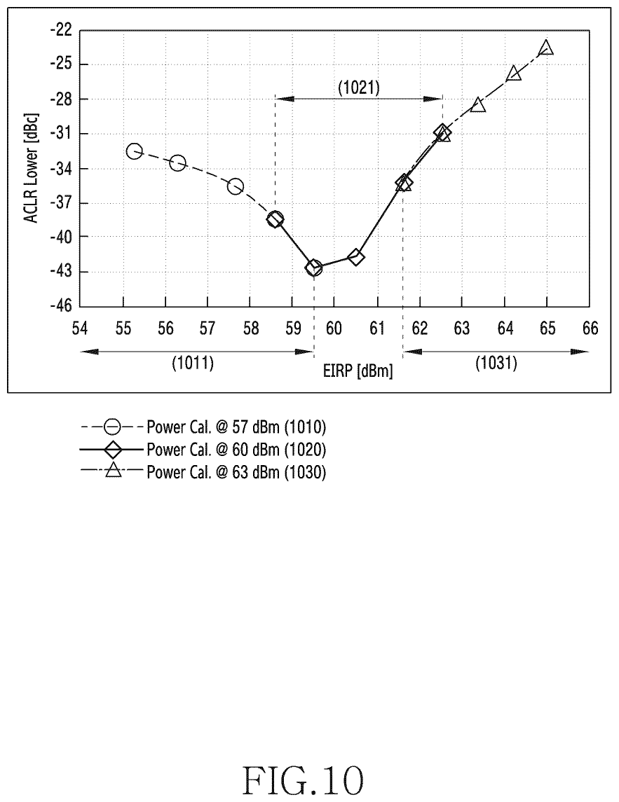

FIG. 10 illustrates an example of performing a selective action on an estimated output according to an embodiment of the disclosure.

Specifically, the selective action may be understood as dividing the output into a plurality of ranges and selectively applying a DPD model suitable for a situation of each range.

Referring to FIG. 10, the estimated EIRP may be divided into a plurality of ranges. For example, as the 60 dBm DPD model is applied, the x-axis in the graph of FIG. 10 may be divided into a first range 1011 positioned to the left of the null and tending to decrease the ACLR value as the x-axis increases, a second range 1021 including the null, and a third range 1031 positioned to the right of the null and tending to increase the ACLR value as the x-axis increases.

As such, the accurate output ranges may be defined by applying the 60 dBm DPD model, and the DPD model suitable for the nonlinearity of each output range may be selectively applied. For example, to produce the target output in the first range 1011, it may be determined to use a DPD model compensating for the nonlinearity at EIRP 57 dBm (1010).

To produce the target output in the third range 1031, it may be determined to use a DPD model compensating for the nonlinearity at EIRP 63 dBm (1030).

For example, in an EIRP range smaller than or equal to 60 dBm, the DPD model different from the DPD model designed to compensate for 60 dBm may be applied. For example, an EIRP range smaller than 60 dBm (e.g., the first range 1011 in FIG. 10) may adopt a DPD model with better performance. For example, an EIRP range higher than 60 dBm (e.g., the third range 1031 in FIG. 10) may adopt a DPD model designed in a harsher environment.

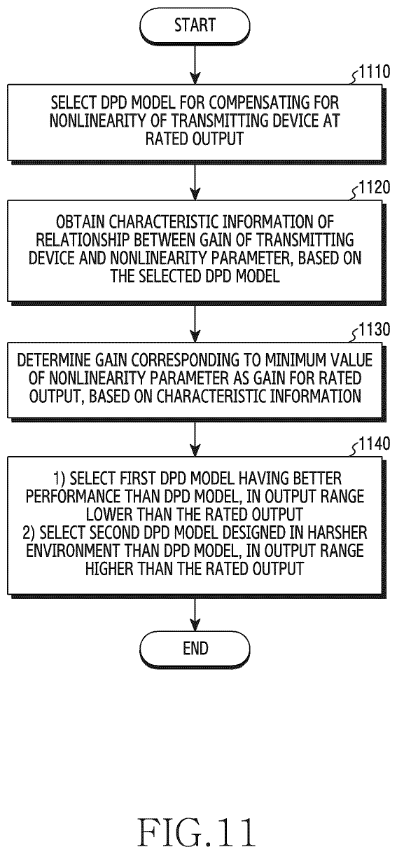

FIG. 11 illustrates a flowchart of performing a selective action on an estimated output according to an embodiment of the disclosure. Descriptions overlapping with operation 810 through operation 830 described above shall be omitted in operation 1110 through operation 1140 of FIG. 11.

In operation 1110, the transmitting device may select a DPD model for compensating for the nonlinearity of the transmitting device at the rated output. As explained above, the rated output may be understood as the target output. For example, if the rated output is 60 dBm, the DPD model selected in operation 1110 may be understood as, for example, the DPD model in which the target output is 60 dBm in FIG. 10. The characteristic information on the relationship between the EIRP of the transmitting device and the nonlinearity parameter obtained based on the DPD model of operation 1110 may be presented as in 1020.

In operation 1120, the transmitting device may obtain the characteristic information on the relationship between the gain of the transmitting device and the nonlinearity parameter, based on the selected DPD model.

In operation 1130, based on the characteristic information, the transmitting device may determine a gain corresponding to the minimum value of the nonlinearity parameter as the gain for the rated output.

The method according to an embodiment of the disclosure enables various LUT selections in operation 1140, through the rated output prediction as in operation 1130. The transmitting device may selectively use various DPD models in various output situations as follows.

In operation 1140, a first DPD model having better performance than the DPD model may be selected in an output range lower than the rated output. In the output range lower than the rated output, a LUT may be generated or used by using the first DPD model. In addition, in an output range higher than the rated output, a second DPD model designed in a harsher environment than the DPD model may be selected. In the output range higher than the rated output, a LUT may be generated or used by using the second DPD model.

In operation 1140, the output range lower than the rated output may be understood as, for example, the first range 1011 in FIG. 10. The first DPD model having better performance than the DPD model selected in operation 1110 may be understood as, for example, the DPD model having the target output of 57 dBm in FIG. 10. The characteristic information on the relationship between the EIRP of the transmitting device and the nonlinearity parameter obtained based on the first DPD model may be presented as in 1010.

In operation 1140, the output range higher than the rated output may be understood as, for example, the third range 1031 in FIG. 10. The second DPD model designed in the harsher environment than the DPD model selected in operation 1110 may be understood as, for example, the DPD model having the target output of 63 dBm in FIG. 10. The characteristic information on the relationship between the EIRP of the transmitting device and the nonlinearity parameter obtained based on the second DPD model may be presented as in 1030.

Specifically, in operation 1140, it may be identified that a specific range corresponds to the output range higher than the rated output. For example, in FIG. 10, it may be identified that the third range 1031 corresponds to the output range higher than the rated output. Referring to FIG. 10, it may be identified that the third range 1031 corresponds to the output range higher than the rated output based on the fact that the slope of the graph in the third range 1031 is greater than 0.

Alternatively, in operation 1140, it may be identified that a specific range corresponds to the output range lower than the rated output. For example, in FIG. 10, it may be identified that the first range 1011 corresponds to the output range lower than the rated output. Referring to FIG. 10, it may be identified that the first range 1011 corresponds to the output range lower than the rated output based on the fact that the slope of the graph in the first range 1011 is smaller than 0.

The slope of the graph in a specific range may be used to identify that the specific range corresponds to the output range higher than the rated output or to identify that the specific range corresponds to the output range lower than the rated output. In addition, the method using the slope is only an example, and does not limit the method of identifying output range higher than or lower than the rated output in the disclosure.

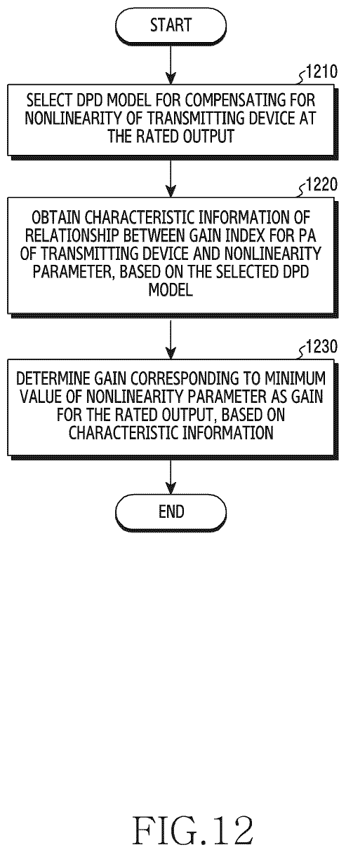

FIG. 12 illustrates a method for estimating an OTA output using a gain index for a PA, according to an embodiment of the disclosure.

The method for estimating the OTA output according to an embodiment may include selecting a DPD model for compensating for the nonlinearity of the transmitting device at the rated output, in operation 1210. In operation 1220, the transmitting device may obtain the characteristic information related to the relationship between the gain index for the PA of the transmitting device and the nonlinearity parameter, based on the selected DPD model. In operation 1230, the transmitting device may determine the gain corresponding to the minimum value of the nonlinearity parameter as the gain for the rated output, based on the characteristic information. Descriptions overlapping with operation 810 through operation 830 of FIG. 8 shall be omitted in operation 1210 through operation 1230.

In operation 1220, the characteristic information on the relationship between the gain index the PA of the transmitting device and the nonlinearity parameter for may be obtained. By using the parameter corresponding to the PA analog gain, calculation required for the DPD modeling and the OTA output estimation may be simplified. For example, the disclosure may use the index, as the separate parameter corresponding to the PA analog gain.

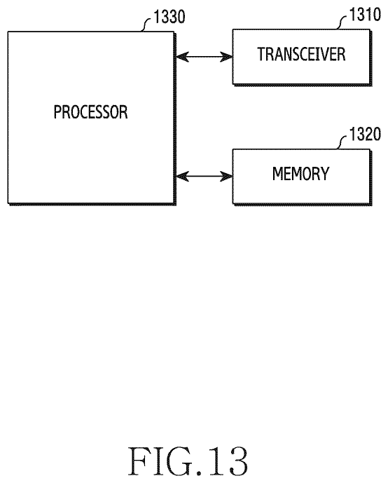

FIG. 13 is a block diagram illustrating an example of a configuration of a transmitting device according to an embodiment of the disclosure.

Referring to FIG. 13, the transmitting device of the disclosure may include a processor 1330, a transceiver 1310, and memory 1320. However, the components of the transmitting device are not limited to the example described above. For example, the transmitting device may include more components or fewer components than the components mentioned above. In addition, the processor 1330, the transceiver 1310, and the memory 1320 may be implemented in the form of a single chip. As explained earlier, the transmitting device may include a base station in an embodiment of the disclosure.

The processor 1330 may control a series of processes to operate the transmitting device according to the embodiment of the disclosure as mentioned above. The processor 1330 may be provided in a singular or plural number, and the processor 1330 may perform the method for estimating the OTA output performed by the transmitting device of the disclosure as explained above by executing a program stored in the memory 1320.

The transceiver 1310 may transmit and receive a signal to and from the receiving device. The signal transmitted and received to and from the receiving device may include control information and data. The transceiver 1310 may include a radio frequency (RF) transmitter for up-converting and amplifying a frequency of a transmitted signal, an RF receiver for low-noise amplifying a received signal and down-converting the frequency, and so on. However, the transceiver 1310 is only an example, and the components of the transceiver 1310 are not limited to the RF transmitter and the RF receiver. In addition, the transceiver 1310 may receive a signal over a wireless channel and output it to the processor 1330, and transmit a signal outputted from the processor 1330 over the wireless channel.

According to an embodiment, the memory 1320 may store a program and data required for the operation of the transmitting device. In addition, the memory 1320 may store control information or data included in signals transmitted and received by the transmitting device. The memory 1320 may include a storage medium such as read only memory (ROM), random access memory (RAM), a hard disk, a compact disc (CD)-ROM, and a digital versatile disc (DVD) or a combination of storage media. In addition, the memory 1320 may be provided in a plural number. According to an embodiment, the memory 1320 may store a program for performing a method of scheduling the receiving device depending on whether a transmitting device mode is a transmitting device energy saving mode or a transmitting device normal mode, which is embodiments of the disclosure described above.

The transmitting device of FIG. 13 may perform the same function as the base station 110 of FIG. 1 and the transmitting device of FIG. 8. The transmitting device of FIG. 13 may include the transceiver 1310; the memory 1320; and the processor 1330 connected to the transceiver 1310 and the memory 1320. The processor 1330 may select the DPD model for compensating for the nonlinearity of the PA of the transmitting device at the rated output, in operation 810 of FIG. 8. In operation 820 of FIG. 8, the processor 1330 may obtain the characteristic information related to the relationship between the gain of the PA of the transmitting device and the nonlinearity parameter, based on the selected DPD model. In operation 830 of FIG. 8, the processor 1330 may determine the gain corresponding to the minimum value of the nonlinearity parameter as the gain for the rated output, based on the characteristic information.

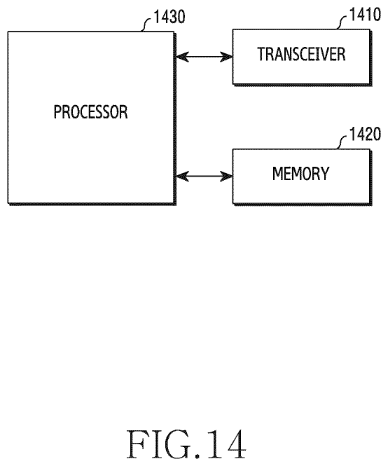

FIG. 14 is a block diagram illustrating an example of a configuration of a receiving device according to an embodiment of the disclosure.

Referring to FIG. 14, the receiving device of the disclosure may include a processor 1430, a transceiver 1410, and memory 1420. However, the components of the receiving device are not limited to the example described above. For example, the receiving device may include more components or fewer components than the components mentioned above. In addition, the processor 1430, the transceiver 1410 and the memory 1420 may be implemented in the form of a single chip. As described above, the receiving device may include a base station in an embodiment of the disclosure.

The processor 1430 may control a series of processes to operate the receiving device according to the embodiment of the disclosure as described above. The processor 1430 may be provided in a singular or plural number, and the processor 1430 may perform the method for estimating the OTA output performed by the receiving device of the disclosure described above by executing a program stored in the memory 1420.

The transceiver 1410 may transmit and receive a signal to and from the receiving device. The signal transmitted and received to and from the receiving device may include control information and data. The transceiver 1410 may be configured with an RF transmitter for up-converting and amplifying the frequency of a transmitted signal, an RF receiver for low-noise-amplifying a received signal and down-converting the frequency, and so on. However, the transceiver 1410 is only an example, and the components of the transceiver 1410 are not limited to the RF transmitter and the RF receiver. In addition, the transceiver 1410 may receive a signal over a wireless channel and output it to the processor 1430, and transmit a signal outputted from the processor 1430 over the wireless channel.

According to an embodiment, the memory 1420 may store a program and data required for the operation of the receiving device. In addition, the memory 1420 may store control information or data included in signals transmitted and received by the receiving device. The memory 1420 may include a storage medium such as a ROM, a RAM, a hard disk, a CD-ROM, and a DVD or a combination of storage media. In addition, the memory 1420 may be provided in a plural number. According to an embodiment, the memory 1420 may store a program for performing a method of scheduling the receiving device depending on whether a receiving device mode is a receiving device energy saving mode or a receiving device normal mode, which is embodiments of the disclosure described above.

A method for estimating an OTA output performed by a transmitting device according to an embodiment of the disclosure may include selecting a DPD model to compensate for nonlinearity of the transmitting device at a rated output; obtaining characteristic information related to a relationship between a gain of the transmitting device and a nonlinearity parameter, based on the selected DPD model; and determining a gain corresponding to a minimum value of the nonlinearity parameter as a gain for the rated output, based on the characteristic information.

Selecting the DPD model may comprises selecting a different DPD model according to a range of the rated output.

Selecting the DPD model may comprises selecting a first DPD model having better performance than the DPD model, in an output range lower than the rated output, and selecting a second DPD model designed in a harsher environment than the DPD model, in an output range higher than the rated output.

Obtaining the characteristic information related to the relationship between the gain of the transmitting device and the nonlinearity parameter may include changing the gain of a power amplifier of the transmitting device; and obtaining the nonlinearity parameter according to the changed gain.

The minimum value of the nonlinearity parameter may be a value corresponding to a null point occurring in the relationship between the gain and the nonlinearity parameter.

Obtaining the characteristic information related to the relationship between the gain of the transmitting device and the nonlinearity parameter may include obtaining the characteristic information related to the relationship between a gain index for the power amplifier of the transmitting device and the nonlinearity parameter.

The nonlinearity parameter may be one of an ACLR or an EVM.

A transmitting device according to an embodiment of the disclosure may include a transceiver; memory; and at least one processor connected to the transceiver and the memory. The at least one processor may control to select a DPD model to compensate for nonlinearity of the transmitting device at a rated output, obtain characteristic information related to a relationship between a gain of the transmitting device and a nonlinearity parameter, based on the selected DPD model, and determine a gain corresponding to a minimum value of the nonlinearity parameter as a gain for the rated output, based on the characteristic information.

The at least one processor may control to use a different DPD model according to a range of the rated output.

The at least one processor may control to select a first DPD model having better performance than the DPD model, in an output range lower than the rated output, and select a second DPD model designed in a harsher environment than the DPD model, in an output range higher than the rated output.

The at least one processor may further control to change the gain of a power amplifier of the transmitting device, and obtain the nonlinearity parameter according to the changed gain.

The minimum value of the nonlinearity parameter may be a value corresponding to a null point occurring in the relationship between the gain and the nonlinearity parameter.

The at least one processor may control to obtain the characteristic information related to the relationship between a gain index for the power amplifier of the transmitting device and the nonlinearity parameter.

The nonlinearity parameter may be one of an ACLR or an EVM.

The methods according to the embodiments described in the claims or the specification of the disclosure may be implemented in software, hardware, or a combination of hardware and software.

In software implementation, a computer-readable storage medium storing one or more programs (software modules) may be provided. One or more programs stored in the computer-readable storage medium may be configured for execution by one or more processors of an electronic device. One or more programs may include instructions for controlling an electronic device to execute the methods according to the embodiments described in the claims or the specification of the disclosure.

Such as a program (software module, software) may be stored to random access memory, non-volatile memory including flash memory, ROM, electrically erasable programmable ROM (EEPROM), a magnetic disc storage device, CD-ROM, DVDs or other optical storage devices, and a magnetic cassette. Alternatively, it may be stored to memory combining part or all of those recording media. In addition, each memory may be included in a plural number.

Also, the program may be stored in an attachable storage device accessible via a communication network such as internet, intranet, local area network (LAN), wide LAN (WLAN), or storage area network (SAN), or a communication network by combining these networks. Such a storage device may access a device which executes an embodiment of the disclosure through an external port. In addition, a separate storage device on the communication network may access the device which executes an embodiment of the disclosure.

In this disclosure, the term “computer program product” or “computer readable medium” is used to collectively refer to a medium such as memory, a hard disk installed in a hard disk drive, and a signal. These “computer program products” or “computer readable media” are configurations provided in a method for reporting terminal capabilities in a wireless communication system according to the disclosure.

A machine-readable storage medium may be provided in the form of a non-transitory storage medium. Herein, ‘non-transitory’ simply means that the storage medium is a tangible device, and does not include a signal (e.g., an electromagnetic wave), but this term does not differentiate between a case where data is semi-permanently stored in the storage medium and a case where the data is temporarily stored. For example, the ‘non-transitory storage medium’ may include a buffer for temporarily storing data.

According to an embodiment, a method according to various embodiments of the disclosure may be included and provided in a computer program product. The computer program product may be traded as a product between a seller and a buyer. The computer program product may be distributed in the form of a machine-readable storage medium (e.g., a CD-ROM), or may be distributed (e.g., downloaded or uploaded) directly or online via an application store (e.g., Play Store™) or between two user devices (e.g., smart phones). In the online distribution, at least a part of the computer program product may be temporarily stored in the machine-readable storage medium such as memory of a manufacturer's server, an application store server, or a relay server, or may be temporarily generated.

In the specific embodiments of the disclosure, the component included in the disclosure is expressed in a singular or plural form. However, the singular or plural expression is appropriately selected according to a proposed situation for the convenience of explanation, the disclosure is not limited to a single component or a plurality of components, the components expressed in the plural form may be configured as a single component, and the components expressed in the singular form may be configured as a plurality of components.

In addition, the respective embodiments may be combined and operated as needed. For example, portions of one embodiment and another embodiment of the disclosure may be combined with each other to operate the base station and the terminal. Further, the embodiments of the disclosure may be applied to other communication system, and other modifications may be made based on the technical idea of the embodiments. For example, the embodiment is applicable to a long term evolution (LTE) system, 5th generation (5G), a new radio (NR) system or a 6th generation (6G) system.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for estimating an over the air (OTA) output performed by a transmitting device, the method comprising:
selecting a digital pre-distortion (DPD) model to compensate for nonlinearity of the transmitting device at a rated output;
obtaining characteristic information related to a relationship between a gain of the transmitting device and a nonlinearity parameter, based on the selected DPD model; and
determining a gain corresponding to a minimum value of the nonlinearity parameter as a gain for the rated output, based on the characteristic information.

2. The method of claim 1, wherein selecting the DPD model comprises selecting a different DPD model according to a range of the rated output.

3. The method of claim 2,
wherein selecting the DPD model comprises:
selecting a first DPD model having better performance than the DPD model, in an output range lower than the rated output, and
selecting a second DPD model designed in a harsher environment than the DPD model, in an output range higher than the rated output.

4. The method of claim 1, wherein obtaining the characteristic information related to the relationship between the gain of the transmitting device and the nonlinearity parameter comprises:
changing a gain of a power amplifier of the transmitting device; and
obtaining the nonlinearity parameter according to the changed gain.

5. The method of claim 1, wherein the minimum value of the nonlinearity parameter is a value corresponding to a null point occurring in the relationship between the gain of the transmitting device and the nonlinearity parameter.

6. The method of claim 1, wherein obtaining the characteristic information related to the relationship between the gain of the transmitting device and the nonlinearity parameter comprises:
obtaining the characteristic information related to the relationship between a gain index for a power amplifier of the transmitting device and the nonlinearity parameter.

7. The method of claim 1, wherein the nonlinearity parameter includes one of an adjacent channel leakage ratio (ACLR) or an error vector magnitude (EVM).

8. A transmitting device comprising:
a transceiver;
memory, comprising one or more storage media, storing instructions; and
one or more processors communicatively coupled to the transceiver and the memory,
wherein the instructions, when executed by the one or more processors individually or collectively, cause the transmitting device to:
select a digital pre-distortion (DPD) model to compensate for nonlinearity of the transmitting device at a rated output,
obtain characteristic information related to a relationship between a gain of the transmitting device and a nonlinearity parameter, based on the selected DPD model, and
determine a gain corresponding to a minimum value of the nonlinearity parameter as a gain for the rated output, based on the characteristic information.

9. The transmitting device of claim 8, wherein the instructions, when executed by the one or more processors individually or collectively, further cause the transmitting device to:
select a different DPD model according to a range of the rated output.

10. The transmitting device of claim 9, wherein the instructions, when executed by the one or more processors individually or collectively, further cause the transmitting device to:
select a first DPD model having better performance than the DPD model, in an output range lower than the rated output; and
select a second DPD model designed in a harsher environment than the DPD model, in an output range higher than the rated output.

11. The transmitting device of claim 8, wherein the instructions, when executed by the one or more processors individually or collectively, further cause the transmitting device to:
change a gain of a power amplifier of the transmitting device; and
obtain the nonlinearity parameter according to the changed gain.

12. The transmitting device of claim 8, wherein the minimum value of the nonlinearity parameter is a value corresponding to a null point occurring in the relationship between the gain of the transmitting device and the nonlinearity parameter.

13. The transmitting device of claim 8, wherein the instructions, when executed by the one or more processors individually or collectively, further cause the transmitting device to:
obtain the characteristic information related to the relationship between a gain index for a power amplifier of the transmitting device and the nonlinearity parameter.

14. The transmitting device of claim 8, wherein the nonlinearity parameter includes one of an adjacent channel leakage ratio (ACLR) or an error vector magnitude (EVM).

15. One or more non-transitory computer-readable storage media storing one or more computer programs including computer-executable instructions that, when executed by one or more processors of a transmitting device individually or collectively, cause the transmitting device to perform operations, the operations comprising:
selecting a digital pre-distortion (DPD) model to compensate for nonlinearity of the transmitting device at a rated output;
obtaining characteristic information related to a relationship between a gain of the transmitting device and a nonlinearity parameter, based on the selected DPD model; and
determining a gain corresponding to a minimum value of the nonlinearity parameter as a gain for the rated output, based on the characteristic information.

16. The one or more non-transitory computer-readable storage media of claim 15, wherein selecting the DPD model comprises selecting a different DPD model according to a range of the rated output.

17. The one or more non-transitory computer-readable storage media of claim 16,
wherein selecting the DPD model comprises:
selecting a first DPD model having better performance than the DPD model, in an output range lower than the rated output, and
selecting a second DPD model designed in a harsher environment than the DPD model, in an output range higher than the rated output.

18. The one or more non-transitory computer-readable storage media of claim 15, wherein obtaining the characteristic information related to the relationship between the gain of the transmitting device and the nonlinearity parameter comprises:
changing a gain of a power amplifier of the transmitting device; and
obtaining the nonlinearity parameter according to the changed gain.

19. The one or more non-transitory computer-readable storage media of claim 15, wherein the minimum value of the nonlinearity parameter is a value corresponding to a null point occurring in the relationship between the gain of the transmitting device and the nonlinearity parameter.

20. The one or more non-transitory computer-readable storage media of claim 15, wherein obtaining the characteristic information related to the relationship between the gain of the transmitting device and the nonlinearity parameter comprises:
obtaining the characteristic information related to the relationship between a gain index for a power amplifier of the transmitting device and the nonlinearity parameter.
